(19) United States
(12) Patent Application Publication
(10) Pub. No.: US 2024/0222825 A1
(43) Pub. Date: Jul. 4, 2024

(54) Secondary Battery, Battery Module and Electrical Device

(71) Applicant: JIANGSU ZENERGY BATTERY TECHNOLOGIES CO., LTD., Suzhou, Jiangsu (CN)

(72) Inventors: Yongjun LI, Dongguan, Guangdong (CN); Juntai LU, Dongguan, Guangdong (CN); Shengli CHEN, Dongguan, Guangdong (CN)

(21) Appl. No.: 18/293,276

(22) PCT Filed: Oct. 19, 2021
(86) PCT No.: PCT/CN2021/124589

§ 371 Date: Jan. 29, 2024

(30) Foreign Application Priority Data
Jul. 29, 2021 (CN) 202110861110.7

(51) Int. Cl. H01M 50/593; H01M 50/147; H01M 50/533

(52) U.S. Cl. CPC H01M 50/593; H01M 50/147; H01M 50/533

(57) ABSTRACT

A secondary battery, a battery module and an electrical device are provided. The secondary battery includes a top cover plate, cell assemblies, and insulators arranged between the top cover plate and the cell assemblies and configured to isolate the cell assemblies from the top cover plate. Each of the cell assemblies includes a cell body and tabs arranged on the cell body; the secondary battery includes electrode terminals, the electrode terminals pass through the top cover plate and the insulators and being connected to the tabs. Bottom ends of the electrode terminals extend along the bottom surfaces of the insulators to form extension parts. The extension parts are fixedly connected to the tabs. According to the disclosure, a connecting piece is omitted, and production parts and procedures are simplified, thereby facilitating reduction of the production cost.

### CROSS-REFERENCE TO RELATED APPLICATION

This application is a National Stage Filing of the PCT International Application No. PCT/CN2021/124589 filed on Oct. 19, 2021, which claims priority to Chinese Patent Application No. 202110861110.7, filed with the China Patent Office on Jul. 29, 2021 and entitled “SECONDARY BATTERY, BATTERY MODULE, AND ELECTRICAL DEVICE”, which is incorporated herein by reference in its entirety.

### TECHNICAL FIELD

The disclosure belongs to the technical field of batteries, and in particular relates to a secondary battery, a battery module, and an electrical device.

### BACKGROUND

With the development of modern society and the enhancement of people's awareness of environmental protection, more and more devices choose to use lithium batteries as power supplies, such as mobile phones, notebook computers, electric tools, electric vehicles, etc., which provides a broad space for the application and development of the lithium batteries. The lithium batteries used in the electric tools and the electric vehicles are generally called power batteries. A plurality of tabs of the cell are welded to a plurality of electrode terminals through a connecting piece, which has been widely used in the top cover of a power battery.

In the existing structure, the plurality of tabs of the cell are ultrasonically welded with the connecting piece first, and the connecting piece is then placed at the bottom of the plurality of electrode terminals of the top cover for laser welding to realize the function of the cell. However, this structure has high cost and many procedures, and the thickness of the connecting piece also increases the internal space of the cell.

### SUMMARY

Some embodiments of the disclosure provide a secondary battery in view of the deficiency of the related art, which omits a connecting piece, simplifies production parts and procedures, and helps to reduce production costs.

In an embodiment mode, the disclosure adopts the following technical solutions:

A secondary battery includes a top cover plate, cell assemblies, and insulators arranged between the top cover plate and the cell assemblies and configured to isolate the cell assemblies from the top cover plate, wherein each of the cell assemblies includes a cell body and tabs arranged on the cell body; the secondary battery includes electrode terminals, the electrode terminals pass through the top cover plate and the insulators and are connected to the tabs; the bottom ends of the electrode terminals extend along the bottom surfaces of the insulators to form extension parts; and the extension parts are fixedly connected to the tabs.

In an embodiment mode, the insulators are configured to isolate the top cover plate from the extension parts, and the extension parts extend along the width direction Y of the top cover plate.

In an embodiment mode, the extension parts extend along the length direction X of the top cover plate.

In an embodiment mode, the insulators include high temperature resistant portions, and the high temperature resistant portions are arranged above the extension parts and made of a high temperature resistant material.

In an embodiment mode, the insulators are integrally or separately arranged with the high temperature resistant portions.

In an embodiment mode, grooves are formed in ends, close to the cell assemblies, of the electrode terminals.

In an embodiment mode, the bottom surfaces of the high temperature resistant portions at least cover first soldering mark regions.

In an embodiment mode, each of the tabs includes a first connecting portion and a first bending portion that are connected in sequence, the first bending portion is configured to the connect the cell body with the first connecting portion, and the first connecting portion is fixedly connected to corresponding extension part of the extension parts.

In an embodiment mode, each of the extension parts and each of the tabs are welded to form a first soldering mark region, and a ratio of the area of the first soldering mark region to the area of the bottom surface of corresponding extension part of the extension parts is less than 0.95; the horizontal distance between an edge of the first soldering mark region and an edge of the corresponding extension part is 0.25 mm-20 mm; and the bottom surface of the extension part is treated by an embossing process.

In an embodiment mode, the secondary battery includes protecting pieces, and each of the protecting pieces includes a second connecting portion and a second bending portion that are connected in sequence, where the second connecting portion is fixed to the bottom surface of the first connecting portion by welding, the second bending portion is bent along an inner surface of the first bending portion, and the first connecting portion and the second connecting portion are welded to form a second soldering mark region.

In an embodiment mode, each of the protecting pieces further includes a turning portion, the turning portion is connected to the second bending portion, and the second connecting portion, the second bending portion and the turning portion form a U-shaped structure.

In an embodiment mode, the top cover plate is further provided with at least one of an explosion-proof valve hole and a liquid injection hole; each of the electrode terminals is sequentially sheathed with a plastic member and a seal ring; the electrode terminals include first electrode terminals and second electrode terminals, the first electrode terminals, a part tabs of the tabs and a part protecting pieces of the protecting pieces electrically connected to the first electrode terminal are all made of an aluminum material, and the second electrode terminal, the other part tabs of the tabs and the other part protecting pieces of the protecting pieces electrically connected to the second electrode terminal are all made of a copper material; and in the length direction of the top cover plate, one of the protecting pieces made of the copper material and the protecting pieces made of the aluminum material is provided with a poka-yoke portion, and the thickness of each of the protecting pieces is 0.1 mm-3 mm.

In an embodiment mode, at least two of the cell assemblies are arranged side by side along the width direction of the top cover plate, and in the width direction Y of the top cover plate, the first connecting portions of the tabs with the same polarity are welded to the bottom surface of the extension part, and the first bending portions of the tabs with the same polarity are bent toward the centers of the cell assemblies arranged side by side.

In an embodiment mode, the disclosure provides a battery module including the above secondary battery.

In an embodiment mode, the disclosure provides an electrical device including the above secondary battery.

In the existing structure, the tabs of the cell are ultrasonically welded with a connecting piece first, and the connecting piece is then placed at the bottom of the electrode terminals of a top cover for laser welding to realize the function of a cell. However, this structure has high cost and many procedures, and the thickness of the connecting piece also increases the internal space of the cell. Therefore, the extension parts are arranged on the electrode terminals, the extension parts are fixed together with the tabs, that is, the electrode terminals are electrically connected with the tabs, to realize the function of the cell. Compared with the existing structure, the electrode terminals are directly and fixedly connected with the tabs, so that the installation of the connecting piece is omitted, the production procedures are simplified, and the situation that the connecting piece occupies the space in the height direction of the battery is avoided, which helps to improve the utilization rate of the space inside the battery, thereby improving the energy density of the battery. Meanwhile, the bottom ends of the electrode terminals extend along the bottom surfaces of the insulators to form extension parts, which helps to increase the contact area between the tabs and the extension parts, improve the current passing performance of the battery, further improve the stability between the tabs and the extension parts, and reduce the probability of an open circuit between the tabs and the extension parts. Two tabs are formed on one side of the cell body, and are respectively fixedly connected to the two electrode terminals with different polarities of the top cover plate to realize the electrical connection between the electrode terminals and the cell body. The insulators play a role of isolating the top cover plate from the extension parts, which reduces the probability of contact between the top cover plate and the extension parts, thereby helping to improve the safety of the battery. According to the disclosure, the connecting piece is omitted, and production parts and procedures are simplified, thereby facilitating reduction of the production costs.

### BRIEF DESCRIPTION OF THE DRAWINGS

The features, advantages, and technical effects of exemplary embodiments of the disclosure will be described below with reference to the accompanying drawings.

FIG. 1 is a schematic structural diagram of Embodiment 1 of the disclosure.

FIG. 2 is a schematic structural diagram of Embodiment 2 of the disclosure.

FIG. 3 is a schematic structural diagram of Embodiment 3 of the disclosure.

FIG. 4 is a schematic structural diagram of Embodiment 4 of the disclosure.

FIG. 5 is a schematic structural diagram of a tab and a protecting piece after welding in Embodiment 4 of the disclosure.

FIG. 6 is a schematic structural diagram of a first electrode terminal installed on a top cover plate in Embodiment 4 of the disclosure.

FIG. 7 is an enlarged view at A in FIG. 6.

FIG. 8 is a schematic structural diagram of a second electrode terminal installed on a top cover plate in Embodiment 4 of the disclosure.

FIG. 9 is an enlarged view at B in FIG. 8.

FIG. 10 is a schematic structural diagram of Embodiment 2 of the disclosure and two cells assembled.

FIG. 11 is a schematic structural diagram of Embodiment 2 of the disclosure and four cells assembled.

FIG. 12 is a schematic structural diagram of Embodiment 4 of the disclosure and two cells assembled.

FIG. 13 is a schematic structural diagram of Embodiment 4 of the disclosure and four cells assembled.

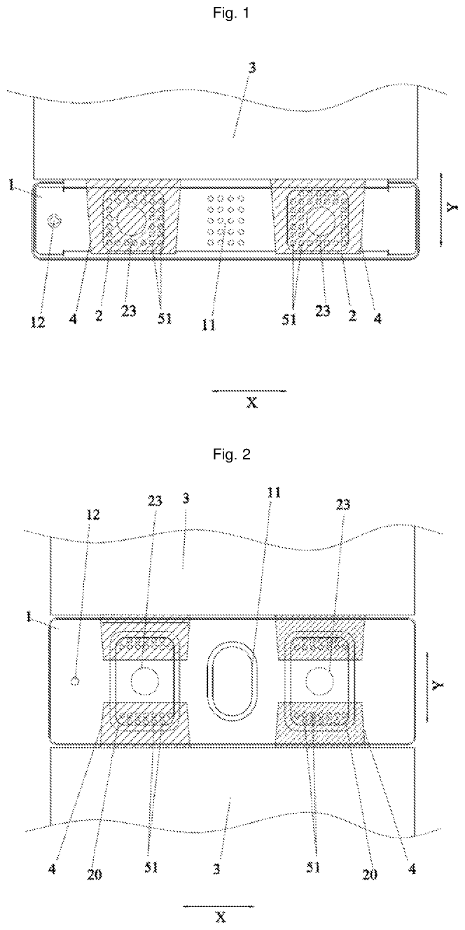

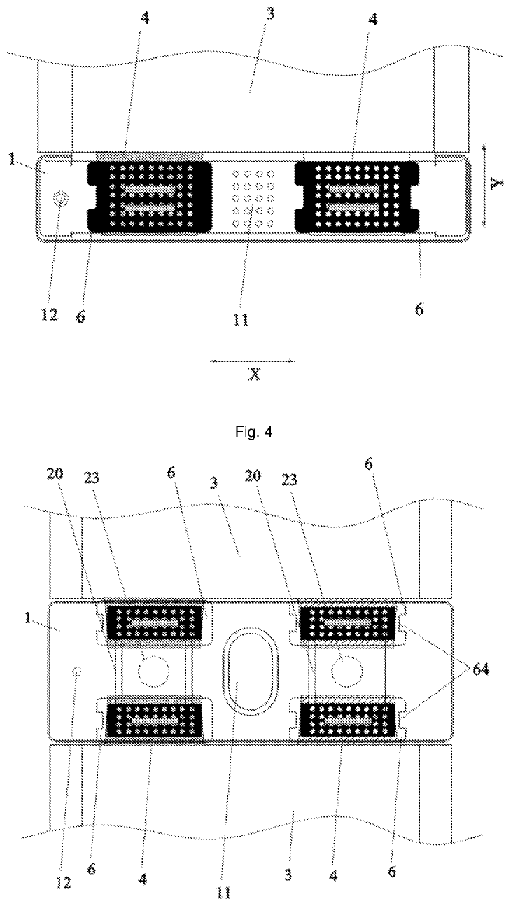

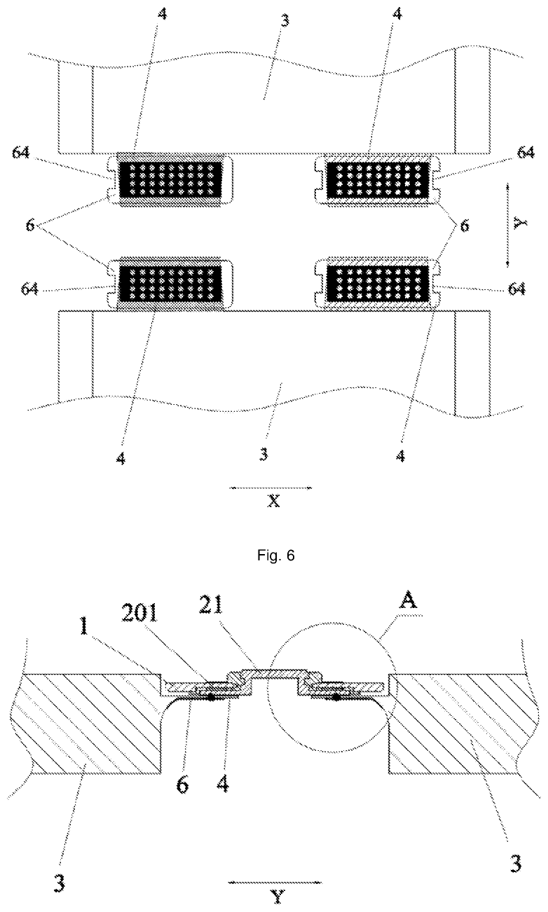

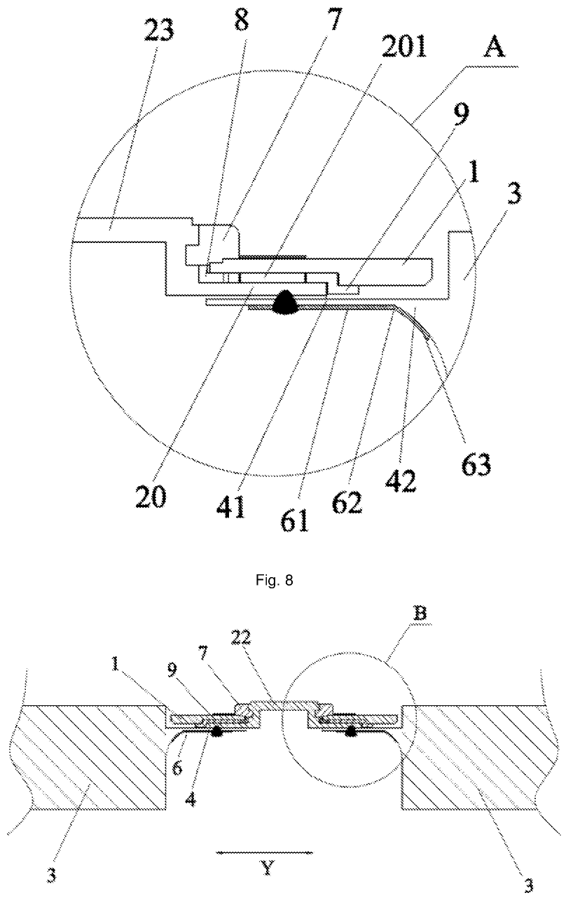

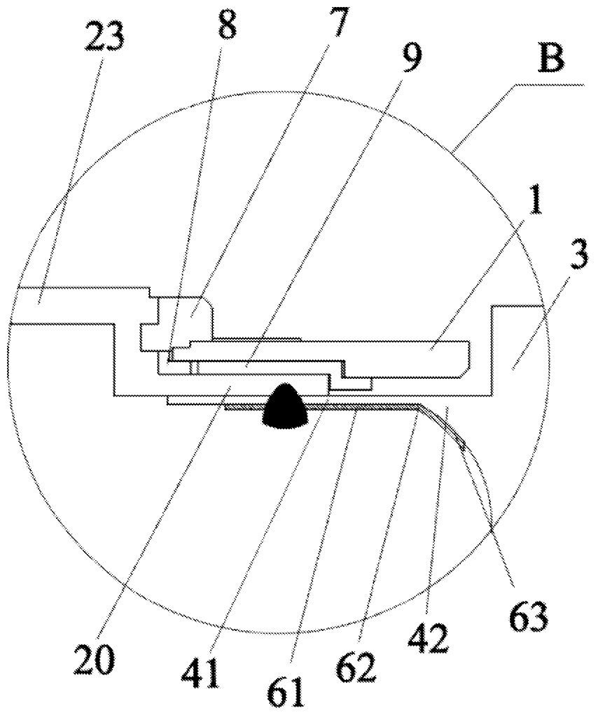

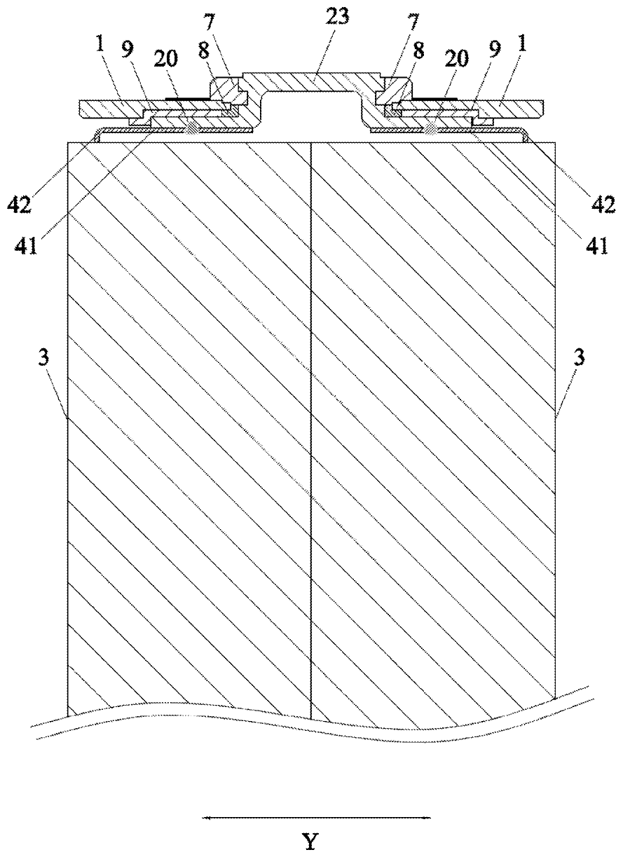

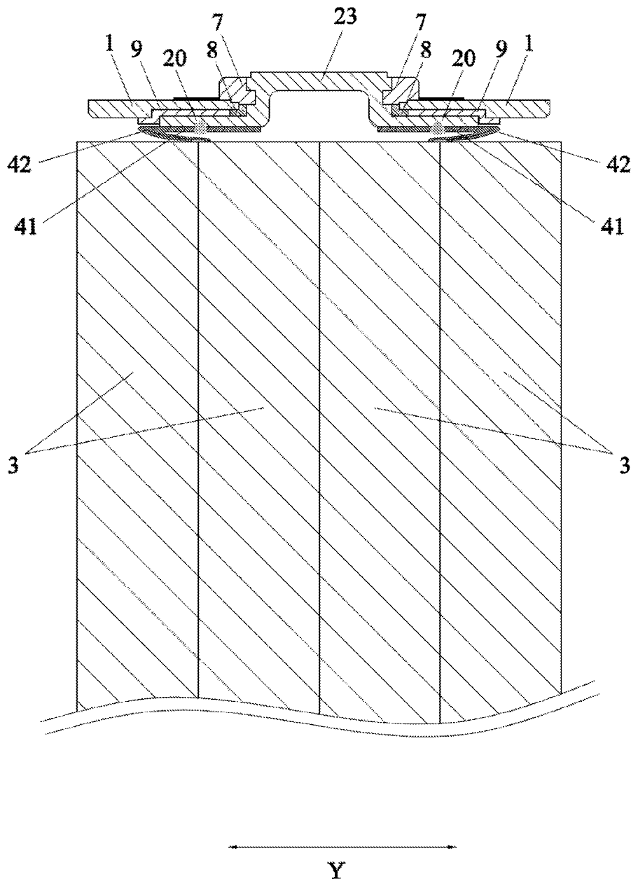

Where, the reference signs are described as follows:
1—top cover plate; 11—explosion-proof valve hole; 12—liquid injection hole;
2—electrode terminal; 20—extension part; 21—first electrode terminal; 22—second electrode terminal; 23—body portion; 201—high temperature resistant portion;
3—cell body;
4—tab; 41—first connecting portion; 42—first bending portion;
51—soldering mark;
6—protecting piece; 61—second connecting portion; 62—second bending portion; 63—turning portion; 64—poka-yoke portion;
7—plastic piece; 8—sealing ring; 9—insulator;
X—length direction; and Y—width direction.

### DETAILED DESCRIPTION OF THE EMBODIMENTS

Certain terms are used, for example, in the specification and claims to refer to particular components. Those skilled in the art should understand that hardware manufacturers may use different terms to refer to the same component. The specification and claims do not use the difference in name as a way to distinguish components, but use the difference in function of components as a criterion for distinguishing. As mentioned throughout the specification and claims, “comprising” is an open-ended term, so it should be interpreted as “including, but not limited to”. “Approximately” means that within an acceptable error range, those skilled in the art may solve technical problems within a certain error range and basically achieve technical effects.

In addition, the terms “first”, “second”, etc. are used for descriptive purposes only, and should not be construed as indicating or implying relative importance.

In the invention, unless otherwise clearly specified and limited, the terms “installation”, “connected”, “connection”, “fixation” and other terms should be understood in a broad sense, for example, it is a fixed connection or a detachable connection, or an integral connection; it is a mechanical connection or an electrical connection; and it is a direct connection or an indirect connection through an intermediary, and it is an internal communication of two components. Those of ordinary skill in the art may understand the specific meanings of the above terms in the disclosure according to specific situations.

The disclosure will be described in further detail below in conjunction with accompanying drawings 1-13, but it is not intended to limit the disclosure.

### Embodiment 1

A secondary battery includes a top cover plate 1, cell assemblies, and insulators 9 arranged between the top cover plate 1 and the cell assemblies and configured to isolate the cell assemblies from the top cover plate 1, where each of the cell assemblies includes a cell body 3 and tabs 4 arranged on the cell body 3; the secondary battery includes electrode terminals 2, the electrode terminals 2 pass through the top cover plate 1 and the insulators 9 and are connected to the tabs 4; the bottom ends of the electrode terminals 2 extend along the bottom surfaces of the insulators 9 to form extension parts 20; and the extension parts 20 are fixedly connected to the tabs 4.

In the existing structure, a plurality of the tabs of the cell are ultrasonically welded with a connecting piece first, and the connecting piece is then placed at the bottom of a plurality of the electrode terminals of a top cover for laser welding to realize the function of a cell. However, this structure has high cost and many procedures, and the thickness of the connecting piece also increases the internal space of the cell. Therefore, extension parts 20 are arranged on the electrode terminals 2, the extension parts 20 are fixed together with the tabs 4, that is, the electrode terminals 2 are electrically connected with the tabs 4, to realize the function of the cell. Compared with the existing structure, the electrode terminals 2 are directly and fixedly connected with the tabs 4, so that the installation of the connecting piece is omitted, the production procedures are simplified, and the situation that the connecting piece occupies the space in the height direction of the battery is avoided, which helps to improve the utilization rate of the space inside the battery, thereby improving the energy density of the battery. Meanwhile, the bottom ends of the electrode terminals 2 extend along the bottom surfaces of the insulators 9 to form extension parts 20, which helps to increase the contact area between the tabs 4 and the extension parts 20, improve the current passing performance of the battery, further improve the stability between the tabs 4 and the extension parts 20, and reduce the probability of an open circuit between the tabs 4 and the extension parts 20. Two tabs 4 are formed on one side of the cell body 3, and are respectively fixedly connected to the two electrode terminals 2 with different polarities of the top cover plate 1 to realize the electrical connection between the electrode terminals 2 and the cell body 3. The insulators 9 play a role of isolating the top cover plate 1 from the extension parts 20, which reduces the probability of contact between the top cover plate 1 and the extension parts 20, thereby helping to improve the safety of the battery.

In this embodiment, the fixing method between the extension parts 20 and the tabs 4 includes, but not limited to, welding, bonding, riveting or clamping, and ultrasonic welding is preferred.

In the secondary battery according to the disclosure, each of the extension parts 20 and each of the tabs 4 are welded to form a first soldering mark region, and a ratio of the area of the first soldering mark region to the area of the bottom surface of corresponding extension part of the extension parts 20 is less than 0.95. Specifically, the tabs 4 are fixed to the extension parts 20 by ultrasonic welding. The tabs 4 are fixed together with the extension parts 20 of the electrode terminals 2 by forming the first soldering mark regions, and the area of each of the first soldering mark regions is less than that of each of the extension parts 20, which not only prevents the first soldering mark regions from exceeding the extension parts 20 to cause damage to the top cover plate 1 or other parts, and may also improve the stability between the tabs 4 and the extension parts 20, reduce the generation of welding slag in the welding process, and help to improve the performance of the battery. Meanwhile, the area of each of the first soldering mark regions is slightly less than that of each of the extension parts 20, so that the contact area between the first soldering mark regions and the extension parts is increased, which helps to improve the current passing capacity between the tabs 4 and the electrode terminals 2, thereby improving the performance of the battery. In some embodiments, each of the tabs 4 include a first connecting portion 41 and a first bending portion 42 that are connected in sequence. The first bending portion 42 is configured to connect the cell body 3 with the first connecting portion 41, and the first connecting portion 41 is fixedly connected with the extension part 20 to realize the electrical connection between the tab 4 and the electrode terminal 2. By arranging the first bending portion 42, the whole tab 4 has a smooth transition during assembly, thereby reducing the probability of scratches or damage to the tab 4.

In this embodiment, at least two cell assemblies are arranged side by side along the width direction Y of the top cover plate 1, and in the width direction Y of the top cover plate 1, the first connecting portions 41 of the tabs 4 with the same polarity are welded to the bottom surface of the extension part 20, and the first bending portions 42 of the tabs 4 with the same polarity are bent toward the centers of the cell assemblies arranged side by side. Specifically, a plurality of cell assemblies are arranged side by side, multiple tabs 4 with the same polarity are connected to the extension part 20 of the same electrode terminal 2, and the area of the bottom surface of the extension part 20 is relatively large, so that the extension part 20 may connect multiple tabs 4 with the same polarity to realize the parallel connection between multiple cell bodies 3. Increasing the number of the cell bodies 3 in the battery helps to improve the energy density of the battery.

In the secondary battery according to the disclosure, the horizontal distance between the edge of the first soldering mark region and the edge of the extension part is 0.25 mm-20 mm. The distance between the edges of the two is limited, so as to prevent the situation that part of the first soldering mark region may exceed the area of the extension part 20 to cause damage to the top cover plate 1 or other parts due to too small distance between the edges of the two, and meanwhile, to prevent the situation that the distance between the edges of the two is too large, and the contact area of the edge of the tab 4 and the extension part 20 is too small, which affects the stability of the edges of the two. In some embodiments, the horizontal distance between the edge of the first soldering mark region and the edge of the extension part 20 is limited to 1 mm-18 mm. In some embodiments, the horizontal distance between the edge of the first soldering mark region and the edge of the extension part 20 is 4 mm, 7 mm, 10 mm, 13 mm or 16 mm.

In the secondary battery according to the disclosure, the bottom surface of the extension part 20 is treated by an embossing process. Specifically, the surface of the extension part 20 corresponding to the tabs 4 is embossed, which may improve the welding effect between the extension parts 20 and the tabs 4 and prevent slippage during welding.

In the secondary battery according to the disclosure, a plurality of soldering marks 51 are uniformly arranged in the first soldering mark region; and each of the soldering marks 51 is square, circular or oval. The soldering marks 51 are uniformly distributed in the first soldering mark region, so that the tabs 4 and the extension parts 20 are uniformly stressed, and meanwhile, the space on the surfaces of the tabs 4 is fully utilized, which helps to improve the stability between the tabs 4 and the extension parts 20.

In the secondary battery according to the disclosure, the grooves are formed in ends, close to the cell assemblies, of the electrode terminals 2, the insulators 9 include high temperature resistant portions, and the high temperature resistant portions 201 are arranged above the extension parts 20 and made of a high temperature resistant material. In this embodiment, the grooves are formed in the approximate centers of the electrode terminals 2, the electrode terminals 2 include body portions 23, the grooves correspond to the positions of the body portions 23, the extension parts 20 are arranged around the edges of the body portions 23, and the high temperature resistant portions 201 are arranged between the extension parts 20 and the top cover plate 1. The extension parts 20 are arranged around the edges of the body portions 23, which may increase the area of the extension parts 20, that is, increase the contact area between the extension parts 20 and the tabs 4, thereby helping to improve the current passing performance between the two. Specifically, the extension parts 20 are extend along the width direction Y of the top cover plate 1, and are also extend along the length direction X of the top cover plate 1, which helps to increase the contact area between the extension parts 20 and the tabs 4, and to improve the overall stability of the two. When welding, the tops of the extension parts 20 correspond to the top cover plate 1 made of the metal. The temperature is relatively high during welding, so that the high temperature resistant portions 201 are arranged between the extension parts 20 and the top cover plate 1. Specifically, if an ordinary insulator 9 is used, the extension part 20 melts, and the insulator 9 forms a through hole, resulting in the conduction between the extension part 20 and the electrode terminal 2, especially short-circuit of the battery at a negative electrode terminal. In addition, because the cost of the high-temperature-resistant insulator 9 is relatively high, it is preferable to install the high-temperature-resistant insulator 20 at the corresponding welding portion, and the rest portion is a common insulator 9, or is a high-temperature-resistant insulator 9. In some embodiments, the insulator 9 is integrally arranged with the high temperature resistant portion 201, which helps to improve the overall mechanical properties of the insulator 9 and simplify the assembly process. Meanwhile, the insulator 9 is separately arranged with the high temperature resistant portion 201 according to the actual production needs and cost. In some embodiments, the bottom surface of the high temperature resistant portion 201 at least covers the first soldering mark region.

The working principle of the disclosure is:

The extension parts 20 are arranged on the electrode terminals 2, the extension parts 20 are fixed together with the tabs 4, that is, the electrode terminals 2 are electrically connected with the tabs 4, to realize the function of the cell. Compared with the existing structure, the electrode terminals 2 are directly and fixedly connected with the tabs 4, so that the installation of the connecting piece is omitted, the production procedures are simplified, and the situation that the connecting piece occupies the space in the height direction of the battery is avoided, which helps to improve the utilization rate of the space inside the battery, thereby improving the energy density of the battery. Meanwhile, the bottom ends of the electrode terminals 2 extend along the bottom surfaces of the insulators 9 to form extension parts 20, which helps to increase the contact area between the tabs 4 and the extension parts 20, improve the current passing performance of the battery, further improve the stability between the tabs 4 and the extension parts 20, and reduce the probability of an open circuit between the tabs 4 and the extension parts 20. The insulators 9 play a role of isolating the top cover plate from the extension parts 20, which reduces the probability of contact between the top cover plate and the extension parts 20, thereby helping to improve the safety of the battery.

### Embodiment 2

The difference from Embodiment 1 is that in this embodiment, two cell bodies 3 are included, where the two tabs 4 of one cell body 3 are fixedly connected to the extension parts 20 of the two electrode terminals 2 respectively, and the two tabs 4 of the other cell body 3 are also fixedly connected to the extension parts 20 of the two electrode terminals 2 respectively. In this embodiment, the cell bodies 3 are arranged side by side. One tab 4 of one cell body 3 of the two cell bodies 3 and one tab 4 of the other cell body 3 of the two cell bodies 3 have the same polarity, and the two tabs 4 with the same polarity are connected to the extension part 20 of the same electrode terminal 2. The extension part 20 is arranged around the edge of the body portion 23, so that the extension part 20 is connect the two tabs 4 with the same polarity, thereby realizing the parallel connection between two the cell bodies 3. Increasing the number of the cell bodies 3 in the battery helps to improve the energy density of the battery.

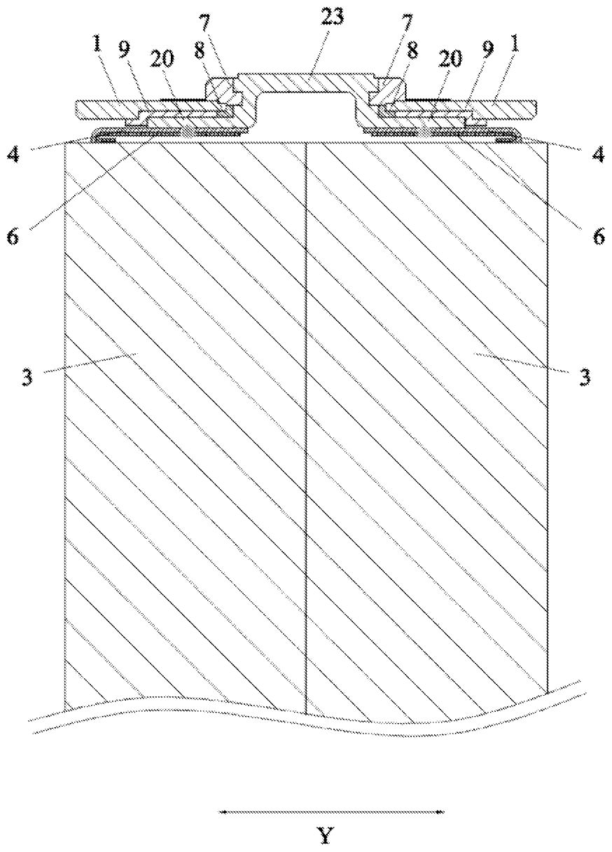

In addition, in some embodiments, four cell bodies 3 further are included. Specifically, four cell assemblies are arranged side by side along the width direction Y of the top cover plate 1. The first bending portions 42 of the tabs 4 with the same polarity are bent toward the centers of the cell assemblies arranged side by side. The first bending portion 42 forms a structure similar to an arc or an L shape. Similarly, a plurality of cell bodies 3 are included. See FIG. 10 and FIG. 11 for details of bending. When the number of the cell bodies 3 is an even number, the tabs 4 of the multiple cell bodies 3 form a substantially symmetrical structure. When the number of the cell bodies is an odd number, the tabs 4 of the multiple cell bodies 3 form an asymmetrical structure. In the width direction Y, the bent shapes of the tabs 4 are adjusted according to the actual structure of a battery.

Other structures are the same as those in Embodiment 1, and will not be repeated here.

### Embodiment 3

The difference from Embodiment 1 is that in this embodiment, the secondary battery further includes protecting pieces 6, and each of the protecting pieces 6 includes a second connecting portion 61 and a second bending portion 62 that are connected in sequence, where the second connecting portion 61 is fixed to the bottom surface of the first connecting portion 41 by welding, the second bending portion 62 is bent along the inner surface of the first bending portion 42, and the first connecting portion 41 and the second connecting portion 61 are welded to form a second soldering mark region; and each of the protecting pieces 6 further includes a turning portion 63, the turning portion 63 is connected to the second bending portion 62, and the second connecting portion 61, the second bending portion 62 and the turning portion 63 form a U-shaped structure. In this embodiment, the protecting pieces 6 are provided to prevent folded parts of the tabs 4 from being inserted into the cell bodies 3 and to prevent the burrs generated by welding from penetrating through the tabs 4 and being even inserted into the cell bodies 3. In order to fix the protecting pieces 6 on the inner surfaces of the tabs 4, the protecting pieces 6 are fixedly connected to the tabs 4 by ultrasonic welding to form the second soldering mark regions. Specifically, the bottom surfaces of the first connecting portions 41 of the tabs 4 are fixedly connected to the second connecting portions 61 of the protecting pieces 6 by ultrasonic welding, and the first bending portions 42 of the tabs 4 are fixedly connected to the second bending portions 62 of the protecting pieces 6 by ultrasonic welding, which helps to increase the area of ultrasonic welding, thereby improving the stability between the tabs 4 and the protecting pieces 6. In some embodiments, after the tabs 4 and the protecting pieces 6 are ultrasonically welded, the protecting pieces 6, the tabs 4 and the electrode terminals 2 are penetrated by laser welding to connect the protecting pieces 6, the tabs 4 and the electrode terminals 2 together, which helps to improve the stability among the protecting pieces 6, the tabs 4 and the electrode terminals 2, and also omits the procedure of ultrasonically welding the tabs 4 and the electrode terminals 2. The turning portions 63 are provided to prevent the tabs 4 inserting upside down into the cell and to play a role of limiting the tabs 4. The first bending portions 42 of the tabs 4 and the second bending portions 62 of the protecting pieces 6 adopt a rounded structure, which helps to reduce the probability of scratching the tabs 4, thereby improving the quality of the battery.

Other structures are the same as those in Embodiment 1, and will not be repeated here.

### Embodiment 4

The difference from Embodiment 3 is that in this embodiment, a secondary battery include two cell bodies 3 and four protecting pieces 6, where the two tabs 4 of one cell body 3 are fixedly connected to the extension parts 20 of the two electrode terminals 2 respectively, the two tabs 4 of the other cell body 3 are also fixedly connected to the extension parts 20 of the two electrode terminals 2 respectively, the four protecting pieces 6 are fixed on the inner surfaces of the four tabs 4 respectively, and in the width direction Y of the top cover plate 1, the two tabs 4 with the same polarity are oppositely welded to the bottom surface of the extension part 20. In this embodiment, the cell bodies 3 are arranged side by side. The two tabs 4 with the same polarity are connected to the extension part 20 of the same electrode terminal 2. The extension parts 20 are arranged around the edges of the body portions 23, so that the extension part 20 connects the two tabs 4 with the same polarity, thereby realizing the parallel connection between two the cell bodies 3. Increasing the number of the cell bodies 3 in the battery helps to improve the energy density of the battery. The four protecting pieces 6 may prevent burrs of the top cover plate 1 from being inserted into the cell bodies 3 to cause damage to the cell bodies 3, also help to prevent short circuits inside the battery, and also play a role of separating the tabs 4 from the top cover plate 1.

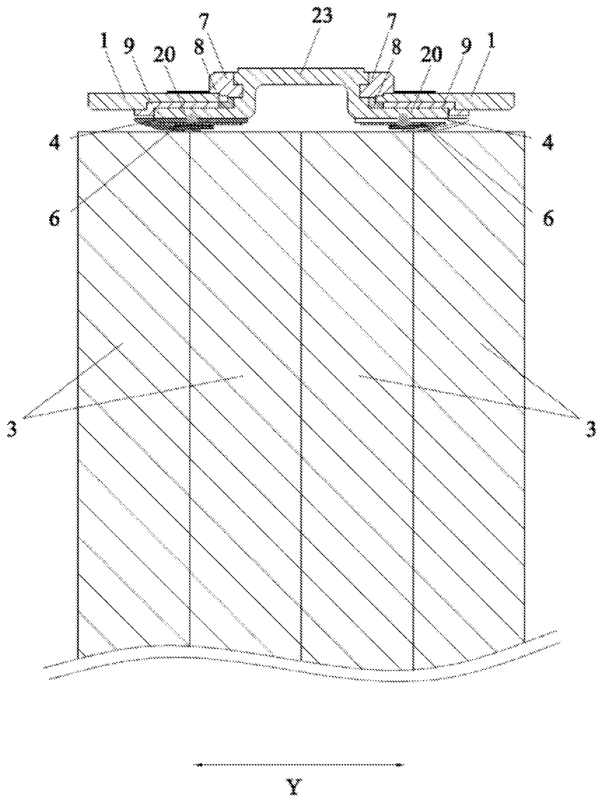

In addition, in some embodiments, the secondary battery further includes four cell bodies 3. Specifically, four cell assemblies are arranged side by side along the width direction Y of the top cover plate 1. The first bending portions 42 of the tabs 4 with the same polarity are bent toward the centers of the cell assemblies arranged side by side. The first bending portion 42 forms a structure similar to an arc or an L shape. Similarly, a plurality of cell bodies 3 is included. See FIG. 12 and FIG. 13 for details of bending.

Other structures are the same as those in Embodiment 3, and will not be repeated here.

### Embodiment 5

The difference from Embodiment 3 is that in this embodiment, the top cover plate 1 is further provided with at least one of an explosion-proof valve hole 11 and a liquid injection hole 12; each of the electrode terminals 2 is sequentially sheathed with a plastic member 7 and a seal ring 8; the electrode terminals 2 include first electrode terminal 21 and second electrode terminal 22, the first electrode terminal 21, the tabs 4 electrically connected to the first electrode terminal 21 and the protecting piece 6 are all made of an aluminum material, and the second electrode terminal 22, the tabs 4 electrically connected to the first electrode terminal 21 and the protecting piece 6 are all made of a copper material; the thickness of each of the protecting pieces 6 is 0.1 mm-3 mm; and in the length direction X of the top cover plate 1, one of the protecting pieces 6 made of the copper material and the protecting pieces 6 made of the aluminum material is provided with a poka-yoke portion 64. Specifically, the electrode terminals 2 are sheathed with the plastic members 7, so that the electrode terminals 2 are fastened to the top cover plate 1, which not only plays an insulating role between the top cover plate 1 and the electrode terminals 2, but also ensures the airtightness between the top cover plate 1 and the electrode terminals 2. The extension parts 20 of the electrode terminals 2 penetrate through the top cover plate 1 to be fixed to the tabs 4, which may improve the stability between the electrode terminals 2 and the tabs 4, prevent the tabs 4 from falling off, and helps to improve the safety of the battery. The a seal ring 8 are an assembly formed by fluoroplastic injection molding or fluororubber die-cutting, which has good electrical insulation performance, high heat resistance, oil resistance, solvent resistance, wear resistance, moisture resistance and low temperature resistance, and helps to prolong the service life of the seal rings 8, thereby improving the safety performance of the cell. The tabs 4 are welded together with the protecting pieces 6. Therefore, the production procedure is simplified, and the situation that the connecting piece occupies the space in the height direction of the battery, which helps to improve the utilization rate of the space inside the battery, thereby improving the energy density of the battery. The liquid injection hole 12 is convenient for injecting electrolyte into the inside of the battery. The top cover plate 1 is equipped with an explosion-proof valve. A protective film is installed on the top of the explosion-proof valve hole 11. When the internal pressure of the battery rises due to overcharge, overdischarge, overcurrent and internal short circuit of the battery, the pressure of the battery is automatically and quickly released to avoid safety accidents due to battery explosion. The protective film may prevent external impurities from entering the explosion-proof valve to affect the function of the explosion-proof valve. In addition, the protecting pieces 6 are provided with poka-yoke portions 64. Specifically, in the length direction X of the top cover plate 1, one of the protecting pieces 6 made of the copper material and the protecting pieces 6 made of the aluminum material is provided with a poka-yoke portion 64, a distinction is made on any one of the protecting pieces 6 dedicated to the copper tabs or the protecting pieces 6 dedicated to the aluminum tabs, that is, the poka-yoke portion 64 is formed, which is convenient for a machine or human eyes to identify, and helps to improve the quality of the battery. The thickness of each of the protecting pieces 6 is limited to avoid the situation that the protecting pieces 6 are too thick, so that the production cost is increased, and the space in the height direction of the top cover plate is occupied, which is not conducive to improving the utilization rate of the space inside the battery, and at the same time, to avoid the situation that the protecting pieces are too thin, so that the mechanical strength of the whole protecting pieces 6 is affected, which is not conducive to prolonging the service life of the battery. In some embodiments, the thickness of each of the protecting pieces 6 is limited to 1 mm-3 mm. In some embodiments, the thickness of each of the protecting pieces is 1.5 mm, 2 mm or 2.5 mm.

Other structures are the same as those in Embodiment 3, and will not be repeated here.

### Battery Module and Electrical Device

The battery module of the disclosure includes the secondary batteries in Embodiments 1-5.

It should be noted that the battery includes a housing and a top cover plate 1, and the housing includes an accommodating space surrounded by a plurality of walls and an opening formed in one side of the accommodating space. The top cover plate 1 is arranged at the opening to close the accommodating space. Electrode terminals 2 are arranged on the top cover plate 1, and the electrode terminals 2 are used as an external conducting terminal of the battery for electrical connection with other components. There are two electrode terminals on the same battery, namely a positive electrode terminal and a negative electrode terminal.

The cell body 3 is a wound structure or a laminated structure. The cell body 3 includes a positive electrode plate, a negative electrode plate and an separator. Specifically, the material of the separator is PP or PE. The positive electrode plate includes a positive current collector and a positive active material layer. The surface of the positive current collector is coated with the positive active material layer. The material of the positive current collector is aluminum. The positive electrode terminal active material is lithium cobaltate, lithium iron phosphate, ternary lithium or lithium manganate, etc. The negative electrode plate includes a negative current collector and a negative active material layer. The surface of the negative current collector is coated with the negative active material layer. The material of the negative current collector is copper. The negative electrode terminal active material is carbon or silicon, etc.

The tabs 4 are used for being electrically connected with the electrode terminals 2 to lead the electric energy of an electrode assembly to the outside of the battery. The tabs 4 are generally arranged on the positive electrode plate and the negative electrode plate in the cell body 3, and the tabs 4 include positive electrode tabs and negative electrode tabs. In order to ensure that a large current passes through the tabs without fusing, there are multiple positive electrode tabs that are stacked together, and there are multiple negative electrode tabs that are stacked together. It is understood that the tabs 4 are directly connected to the electrode terminals 2, that is, the tabs 4 are directly welded to the electrode terminals 2.

The electrical device of the disclosure includes the secondary batteries of Embodiments 1-5.

It should be noted that the electrical device is a vehicle, a mobile phone, a portable device, a notebook computer, a ship, a spacecraft, an electric toy, an electric tool, etc. The vehicle is a fuel vehicle, a gas vehicle or a new energy vehicle. The new energy vehicle is a pure electric vehicle, a hybrid vehicle or an extended-range vehicle. The spacecraft includes an airplane, a rocket, a space shuttle, a spacecraft, etc. The electric toy includes a fixed or mobile electric toy, such as a game console, an electric car toy, an electric boat toy, an electric airplane toy, etc. The electric tool includes a metal cutting electric tool, an electric grinding tool, an electric assembly tool and a railway electric tool, for example, an electric drill, an electric grinder, an electric wrench, an electric screwdriver, an electric hammer, an electric impact drill, a concrete vibrator and an electric planer, etc. The disclosure is not particularly limited to the above electrical devices.

According to the disclosure and teaching of the above specification, those skilled in the art to which the disclosure pertains may also change and modify the above embodiments. Therefore, the disclosure is not limited to the above specific embodiments, and any obvious improvement, substitution or modification made by those skilled in the art on the basis of the disclosure shall fall within the protection scope of the disclosure. In addition, although some specific terms are used in this specification, these terms are only for convenience of description and do not constitute any limitation to the disclosure.

What is claimed is:

1. A secondary battery, comprising:
a top cover plate, cell assemblies, and insulators arranged between the top cover plate and the cell assemblies and configured to isolate the cell assemblies from the top cover plate;
each of the cell assemblies comprises a cell body and tabs arranged on the cell body;
the secondary battery comprises electrode terminals, the electrode terminals pass through the top cover plate and the insulators and being connected to the tabs;
wherein the bottom ends of the electrode terminals extend along the bottom surfaces of the insulators to form extension parts, and the extension parts are fixedly connected to the tabs;
the insulators comprise high temperature resistant portions, the high temperature resistant portions being arranged above the extension parts and made of a high temperature resistant material.

2. The secondary battery according to claim 1, wherein the insulators are configured to isolate the top cover plate from the extension parts, and the extension parts extend along the width direction Y of the top cover plate.

3. The secondary battery according to claim 2, wherein the extension parts extend along the length direction X of the top cover plate.

4. (canceled)

5. The secondary battery according to claim 1, wherein grooves are formed in ends, close to the cell assemblies, of the electrode terminals, the electrode terminals comprise body portions, the grooves correspond to the positions of the body portions, the extension parts are arranged around the edges of the body portions.

6. The secondary battery according to claim 4, wherein each of the tabs comprises a first connecting portion and a first bending portion that are connected in sequence, the first bending portion being configured to the connect the cell body with the first connecting portion, and the first connecting portion being fixedly connected to corresponding extension part of the extension parts.

7. The secondary battery according to claim 6, wherein each of the extension parts and each of the tabs are welded to form a first soldering mark region the area of the first soldering mark region is less than the area of the bottom surface of corresponding extension part of the extension parts.

8. The secondary battery according to claim 7, wherein the secondary battery comprises protecting pieces, each of the protecting pieces comprises a second connecting portion and a second bending portion that are connected in sequence, the second connecting portion being fixed to the bottom surface of the first connecting portion by welding, the second bending portion being bent along an inner surface of the first bending portion, and the first connecting portion and the second connecting portion being welded to form a second soldering mark region.

9. The secondary battery according to claim 8, wherein each of the protecting pieces further comprises a turning portion, the turning portion being connected to the second bending portion, and the second connecting portion, the second bending portion and the turning portion forming a U-shaped structure.

10. The secondary battery according to claim 8, wherein the bottom surfaces of the high temperature resistant portions at least cover the first soldering mark region.

11. The secondary battery according to claim 8, wherein the top cover plate is further provided with at least one of an explosion-proof valve hole and a liquid injection hole;
each of the electrode terminals is sequentially sheathed with a plastic member and a seal ring; the electrode terminals comprise first electrode terminal and second electrode terminal, the first electrode terminal, a part tabs of the tabs and a part protecting pieces of the protecting pieces electrically connected to the first electrode terminal are all made of an aluminum material, and the second electrode terminal, the other part tabs of the tabs and the other part protecting pieces of the protecting pieces electrically connected to the second electrode terminal are all made of a copper material; and
in the length direction X of the top cover plate, one of the protecting pieces made of the copper material and the protecting pieces made of the aluminum material is provided with a poka-yoke portion, and the thickness of each of the protecting pieces is 0.1 mm-3 mm.

12. The secondary battery according to claim 10, wherein at least two of the cell assemblies are arranged side by side along the width direction Y of the top cover plate, and in the width direction Y of the top cover plate, the first connecting portions of the tabs with the same polarity are welded to the bottom surface of the extension part, and the first bending portions of the tabs with the same polarity are bent toward centers of the cell assemblies arranged side by side.

13. A battery module, comprising the secondary battery according to claim 1.

14. An electrical device, comprising the secondary battery according to claim 1.

15. The secondary battery according to claim 8, wherein the first bending portions of the tabs are fixedly connected to the second bending portions of the protecting pieces by welding.

16. The secondary battery according to claim 7, wherein a ratio of the area of the first soldering mark region to the area of the bottom surface of corresponding extension part of the extension parts is less than 0.95.

17. The secondary battery according to claim 7, wherein the horizontal distance between an edge of the first soldering mark region and an edge of the corresponding extension part is 0.25 mm-20 mm.

18. The secondary battery according to claim 7, wherein the bottom surface of the extension part is treated by an embossing process.

19. The secondary battery according to claim 10, wherein a plurality of soldering marks are arranged in the first soldering mark region; and each of the soldering marks is square, circular or oval.

20. The secondary battery according to claim 12, wherein each of the first bending portion forms a structure similar to an arc or an L shape.
